(19) United States
(12) Patent Application Publication
(10) Pub. No.: US 2019/0226876 A1
(43) Pub. Date: Jul. 25, 2019

(54) SENSOR

(71) Applicant: Wuhan China Star Optoelectronics Semiconductor Display Technology Co., Ltd., Wuhan (CN)

(72) Inventor: Ping CHEN, Shenzhen (CN)

(21) Appl. No.: 16/129,361

(22) Filed: Sep. 12, 2018

Related U.S. Application Data
(63) Continuation of application No. PCT/CN2018/076339, filed on Feb. 11, 2018.

(30) Foreign Application Priority Data
Jan. 23, 2018 (CN) 201810065007.X

(51) Int. Cl. G01D 5/20

(52) U.S. Cl. CPC G01D 5/2033

(57) ABSTRACT

The present disclosure relates to a sensor for sensing a location of a substrate on a machine table for manufacturing liquid crystal panel. The machine table includes rotating shafts fixed thereon and rollers sleeved on the rotating shafts. The sensor includes a magnetic unit, at least one coil, and a sensing circuit. The magnetic unit is fixed on at least one roller. The coil is arranged within the rotating shaft, and the sensing circuit connects to the coil. When the substrate reaches the location of the roller, the roller drives the magnetic unit to rotate together with the rotating axis, and the current may be generated by cutting the magnetic force line via the coil. The operator may monitor the electrical signals of the sensing circuit to determine the location of the substrate on the machine table.

### CROSS REFERENCE TO RELATED APPLICATIONS

This application is a continuing application of PCT Patent Application No. PCT/CN2018/076339, entitled “SENSOR”, filed on Feb. 1, 2018, which claims priority to Chinese Patent Application No. 201810065007.X, filed on Jan. 23, 2018, both of which are hereby incorporated in its entireties by reference.

### BACKGROUND

### 1. Technical Field

The present disclosure relates to liquid crystal panel field, and more particularly to a sensor on a machine table.

### 2. Description of Related Art

In the manufacturing process of the liquid crystal panel, a plurality of large-scale devices are connected in series on the machine table, and the substrates in the process are slid through the rollers provided on the machine table and flow in each in a predetermined sequence to form a streamlined operation. The roller is disposed on the rotating shaft. A plurality of the rotating shafts are arranged side by side on the machine table along the flow direction of the machine bed. The rotating shaft is perpendicular to the flow direction of the machine table. Inside some devices, the shall and the roller are also provided for the substrate to move in and out of the device. In the manufacturing process of the substrate, a sensor is required to position the substrate.

At present, there are mainly two sensors in sensing the position of the substrate, such as an optical sensor and a mechanical rocker sensor. The optical sensor determines whether there is a substrate by emitting light and the intensity of reflected light from the substrate. However, in locations where the device has a large amount of water vapor, such as a cleaning section and a developing section, water vapor may cause false alarms for such sensors. Thus, so most of these sensors are only adopted for dry sections of the machine. For the wet section of the machine, a rocker sensor may be adopted. When no substrate passes through, the rocker sensor is in a vertical state. When the substrate is transferred to the location of the sensor, the rocker is pressed downward by the substrate, such that the sensor may obtain the corresponding substrate signals. The rocker type sensor transmits information by mechanical rotation, and thus there is no errors due to water vapor or the like. However, due to the limited working principle of the rocker sensor, the mounting height on the machine bed needs to be higher than the roller by a certain distance in order to be pressed down by the substrate. In the wet section of the machine, the rocker sensor is prone to cause the rotating friction force to become large due to prolonged contact with the liquid during the manufacturing process, and it cannot be pressed normally, resulting in fragmentation of the substrate.

### SUMMARY

The present disclosure relates to a sensor suitable for dry and wet sections of the machine table. Also, the structure is simple, and the reliability may be enhanced.

In one aspect, a sensor for sensing a location of a substrate on a machine table for manufacturing liquid crystal panel is provided. The machine table includes rotating shafts fixed thereon and rollers sleeved on the rotating shafts. The rollers are arranged and configured to slide along an axis direction of the rotating shaft. The sensor includes

a magnetic unit, at least one coil, and a sensing circuit; the magnetic unit being fixed on at least one roller; the coil being arranged within the rotating shaft, a winding direction of the coil being along an axis direction of the rotating shaft, and the coil being an open-loop circuit; and the sensing circuit connecting with the cod to form a closed-loop circuit, and the closed-loop being configured to detect a current generated when the coil senses a rotation of the roller to detect a location of the substrate.

Wherein the coil includes two poles protruding from the shaft, and the sensing circuit includes two wires respectively connecting the two poles of the coil, and an indicator connecting between the two wires.

Wherein the sensing circuit further includes a current a for amplifying current signals sensed by the sensor.

Wherein the sensing circuit further includes an signal processing unit for converting the current sensed by the sensor into electrical signals.

Wherein the magnetic unit includes at least one pair of N-pole magnetic unit and S-pole magnetic unit, and at least a portion of a magnetic force line formed by the N-pole magnetic unit and the S-pole magnetic pole passes through the rotating shaft.

Wherein the magnetic unit is sealed inside the roller.

Wherein the rotating shaft is divided a plurality of sections along the axial direction, and each of the sections of the rotating shaft includes at least one roller having the magnetic unit.

Wherein an outer diameter of the roller having the magnetic unit is not smaller than the outer diameter of other rollers.

Wherein the sensor includes a plurality of sets of coils arranged inside the rotating shaft, and the coils are connected in series as an open-loop circuit.

Wherein the rollers are arranged side by side on the machine table, and the sensor is arranged between two adjacent shafts.

In view of the above, the magnetic unit having at least one pair of N-pole magnetic unit and S-pole magnetic unit form a magnetic force line passing through the rotation shaft. The coils are arranged within the rotating shaft, and a winding direction of the coils is along an axis direction of the rotating shaft. The sensing circuit connects to the coil. When the roller passes by the substrate, the roller rotates when being contacted with the substrate. The magnetic force line within the roller rotates with respect to the roller. The coils generate the current when the magnetic force line is cut. The sensing circuit receives the current and generates corresponding electronic signals. The operator may monitor the electrical signals of the sensing circuit to determine the location of the substrate on the machine table. Not only the structure of the sensor is simple, but also the reliability may be enhanced. In addition, the sensor may be adopted in dry and set sections of the machine table so as to enhance the yield rate of the manufacturing process of the liquid crystal panels.

### BRIEF DESCRIPTION OF THE DRAWINGS

FIG. 1 is a schematic view of a sensor in accordance with one embodiment in the present disclosure.

FIG. 2 is a schematic view of the internal structure of the sensor in accordance with one embodiment of the present disclosure.

FIG. 3 is a schematic view of a sensor in accordance with another embodiment in the present disclosure.

### DETAILED DESCRIPTION

Following embodiments of the invention will now be described in detail hereinafter with reference to the accompanying drawings.

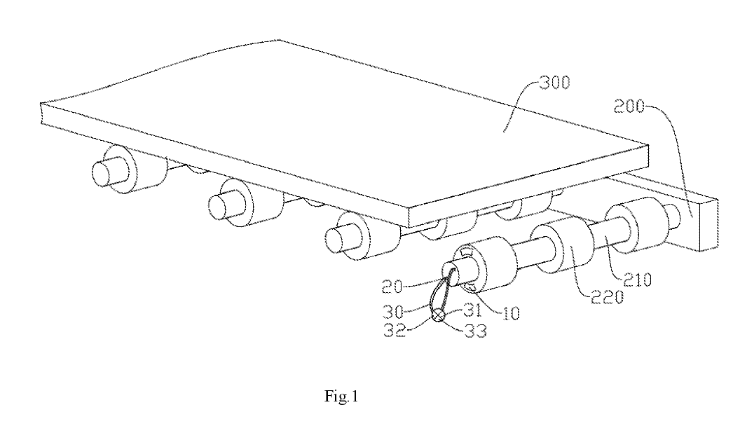

Referring to FIG. 1, on a machine table 200 for the manufacturing process of the liquid crystal panel, a plurality of rotating shafts 210 are fixedly arranged along a flow path of the machine table 200, and a roller 220 is disposed on the rotating shaft 210 for rotation. The substrate 300 for producing a liquid crystal panel realizes the sequential circulation on the machine table 200 by sliding with respect to the roller 220. The sensor 100 described herein includes a magnetic unit 10, a coil 20, and a sensing circuit 30. The magnetic unit 10 is fixed on at least one of the rollers 220. The magnetic unit 10 includes at least one pair of N-pole magnetic unit 11 and S-pole magnetic unit 12.

In this embodiment, the N-pole magnet unit 11 and the S-pole magnet unit 12 are arranged on two lateral sides of a rotation center of the roller 220, and the N-pole magnet unit 11 and the S-pole are symmetrical to each other with respect to the rotation center of the roller 220. Thus, the N-pole magnet unit 11 and the S-pole magnet unit 12 form magnetic force passing through the center of rotation of the roller 220. Since the roller 220 rotates around the rotation shaft 210, that is, the N-pole magnet unit 11 and the S-pole magnet unit 12 form a magnetic three line passing through the rotation shaft 210. The coil 20 is disposed inside the shaft 210. The winding direction of the coil 20 is along an axis direction of the rotating shaft 210, wherein the axial direction refers to the extending direction of the axis. In order to achieve the purpose of cutting magnetic lines of force, the position of the coil 20 in the shaft 210 needs to correspond to a mounting position of the magnetic unit 10, that is, the coil 20 needs to penetrate a projection section of the roller 220 of the magnetic unit 10 on the axis of the shaft 210. The coil 20 is an open-loop circuit, and both ends of the open-loop circuit are connected by the sensing circuit 30 to form a closed loop. Alternatively, the coil 20 cooperates with the sensing circuit 30 to form a closed-loop circuit. The sensing circuit 30 is configured to sense the current on the coil 20.

The roller 220 is configured for carrying the substrate 300 such that the substrate 300 slides along a flow path. When the substrate 300 slides to the roller 220 equipped with the magnetic unit 10, the substrate 300 comes into contact with the roller 220, the substrate 300 slides on the roller 220, and the roller 220 rotates around the rotation center due to friction.

The rotation center of the roller 220 is the axis of the rotation shaft 210. The roller 220 drives the magnetic unit 10 to rotate together. At this time, the magnetic unit 10 passes through the pair of the N-pole magnet unit 11 and the S-pole magnet unit 12 at the axis of the rotation shaft 210. The rotation of the magnetic unit 10 also forms a cutting action of the magnetic induction wire around the axis. The coil 20 is fixed inside the rotating shaft 210. Since the magnetic induction line is stationary relative to the rotating magnetic induction line, the magnetic induction line is cut, and a current is generated on the coil 20 due to a magnetic induction phenomenon. Since the coil 20 and the sensing circuit 30 are connected as a closed-loop circuit, a current passes through the sensing circuit 30. Therefore, the operator can measure the sensing circuit 30 through an electric meter, an inductor, or the like, and the current signals can be monitored. Because the roller 220 is in a stationary state with respect to the rotating shaft 210 when the substrate 300 does not pass through, the roller 220 only has sliding friction with the roller 220 when the substrate 300 passes through the roller 220. When rotation occurs, no current flows through the sensing circuit 30, and the operator can conclude that the substrate 300 does not pass through and contacts with the roller 220 at the position of the roller 220. Conversely, when a current passes through the sensing circuit 30, it can be determined that the substrate 300 passes over the position of the roller 220, thereby positioning the substrate 300 at a specific position on the machine table 200.

The sensor 100 of the present disclosure adopts the principle of mechanical contact, compared with the shortcoming that the optical sensor cannot work normally in the wet section of the machine 200, the mechanical-contact type sensor 100 has no such limitation. By adoption the roller 220 rotating relative to the rotating shaft 210, the disadvantages of the conventional rocker sensor may be avoided. The sensor 100 described in the present disclosure would not damage the substrate even after the sensor 100 is damaged. On the other hand, the positioning accuracy of the rotating shaft 210 and the roller 220 can be used to avoid the disadvantage of the low precision of the friction roller sensor. That is, the sensing accuracy of the sensor 100 in the present disclosure does not depend on the sensor 100 itself, the relative rotation speed between the magnetic unit 10 and the coil 20, the cutting magnetic line angle, and the like. The factor that really affects the sensing accuracy of the sensor 100 described herein is the installation accuracy of the roller 220 and the shaft 210. Specifically, the positioning accuracy of the sensor 100 with respect to the substrate 300 depends on the installation accuracy of the rotating shaft 210 and the roller 220.

The machine 200 equipped with the sensor 100 according to the present disclosure has a high adaptability to the environment, so that the machine 200 can be provided with an uniform sensor in its dry section and wet section to position the substrate 300. At the same time, the configuration of the rotating shaft 210 and the roller 220 of the machine table 200 do not affect the normal operation of the machine table 200, and also avoid the fragmentation of the substrate 300. Not only higher reliability may be obtained, but also higher production yield of LCD panel may be realized.

It can be understood that, in the present embodiment, the N-pole magnet unit 11 and the S-pole magnet unit 12 are symmetrically to each other with respect to the rotation center of the roller 220. In other embodiments, the N-pole magnet unit 11 and the S-pole magnet unit 12 may not be symmetrically disposed, and may not even be completely disposed on two lateral sides of the rotation center of the roller 220. That is, only at least a portion of the magnetic force line need to be pass through the rotating shafts 210. The rotating shaft 210 can enable the coil 20 to cut the magnetic force line when the roller 220 rotates, which can also achieve the effect achieved by the technical solution described in this application.

In the above embodiment, the current generated by the magnetic unit 10 during the rotation of the coil 20 may be small and not be easily captured by the operator. In order to increase the working efficiency of the sensor 100, a larger induced current is generated under a predetermined rotating, and the following optimization settings can also be performed.

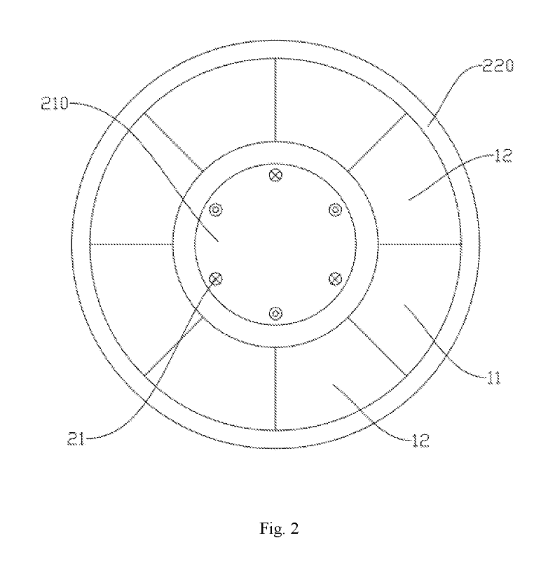

In one embodiment, see FIG. 2, the roller 220 includes a plurality of pairs of the magnetic units 10, and a plurality of pairs of the N-pole magnet unit 11 and the S-pole magnet unit 12 are symmetrically to each other at two lateral sides of the rotation center of the roller 220. The pairs of the magnetic units 10 can ensure that more magnetic force lines perpendicular to the rotating shaft 210 are generated within the roller 220, so that the coil 20 can cut more magnetic force lines during the rotation of the roller 220. The magnetic force lines may generate more current to be sensed by the sensing circuit 30.

Further, in a circumferential direction along the roller 220, the magnetic attributes of two adjacent magnetic blocks are mutually exclusive. That is, the magnetic poles of two adjacent magnets blocks are different. In the case where the roller 220 is rotated by the friction of the substrate 300, the same rotational speed produces a more frequent magnetic pole shift, so that the current frequency is increased to be sensed by the sensing circuit 30.

In some other embodiments, the coils 20 are arranged in multiple groups, and the multiple groups of the coils 20 are all wound along the axis extending direction of the rotating shaft 210. A plurality of sets of the coils 20 are all disposed inside the rotating shaft 210, and a plurality of sets of the coils 20 are connected in series as an open-loop circuit. Such setting increases the cutting area of the magnetic flux by increasing the number of windings of the coil 20 when the rotation speed of the roller 220 and the number of the magnetic units 10 are fixed, and the sensor 100 can also be increased. The generated current is sensed by the sensing circuit 30.

In one embodiment, a current amplifier 32 is further provided on the sensing circuit 30 for obtaining clearer current signals. It can be understood that the current amplifier can amplify the current signals on the sensing circuit 30 so that the operator can more effectively extract the signal. It can be understood that a flitter may also be disposed on the sensing circuit 30 for filtering the interference signals.

As shown in FIG. 1, the coil 20 includes two poles protruding from the shaft 210. The sensing circuit 30 includes two wires respectively connecting the two poles of the coil 20, and an indicator 31 connecting between the two wires. The indicator 31 may generate electrical, acoustic, light, and other forms of reminders through the current signal sensed by the inductor 100 to inform the operator that the substrate 300 has reached the location of the sensor 100. In some embodiments, the sensing circuit 30 is further connected with an signal processing unit 33 for converting the current sensed by the sensor 100 into electrical signals. When the control system of the machine 200 receives the electrical signals, the corresponding functions can be turned on or off according to the specific location of the substrate 300.

The coil 20 is disposed inside the rotating shaft 210, so that the moisture of the wet section in the machine 200 can be isolated. However, the magnetic unit 10 is fixed on the roller 220. If the roller 220 does not provide certain protection for the magnetic unit 10, the magnetic unit 10 will be exposed to the moisture environment for a long period of time. In particular, medicines or chemicals may be adopted on the individual wet sections, and the long-term exposure of the magnetic unit 10 may affect the reliability of the sensor 100. Although the magnetic unit 10 may fail, the substrate may not be directly damaged due to the long-term exposure. For this purpose, in an embodiment, the magnetic unit 10 is sealed and disposed inside the roller 220, and the magnetic unit 10 is wrapped with the roller 220 so that the magnetic unit 10 does not directly contact moisture, etc. The magnetic unit 10 can be protected.

Since the width of the substrate 300 is large, a plurality of rollers 220 are provided on the same shaft 210. The plurality of rollers 220 are arranged side by side along the axis direction of the shaft 210. When the substrate 300 is partially warped or torsionally deformed due to high temperature, stress concentration, or the like during the process, the substrate 300 may not contact with the roller 220 for a period of time. On the other hand, if the shaft 210 has problems such as poor straightness or bending deformation after long-term use, the position of the roller may be misaligned at a certain stage and the substrate 300 may not contact with the substrate 300. Such a situation will cause the substrate 300 to be unable to contact with the roller 220, there will be no friction when the substrate 300 slides over the roller 220, and the roller 220 will not rotate with the rotating shaft 210. If this phenomenon occurs on the roller 220 that mounts the magnetic unit 10, the sensor 100 will thus cause a non-operation situation, which cannot effectively reflect the current position status of the substrate 300.

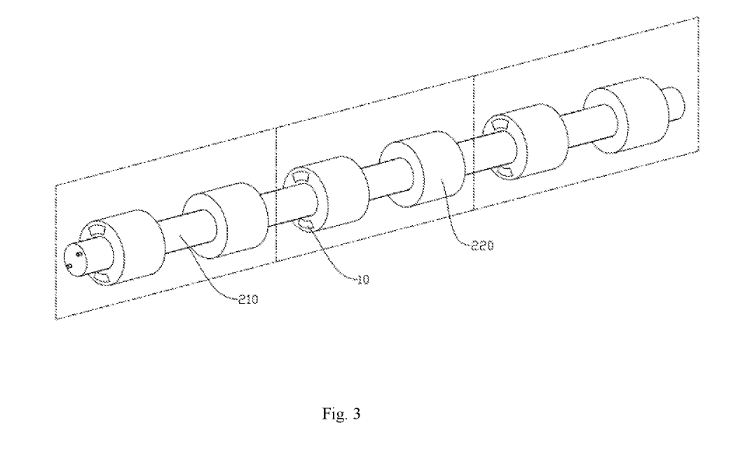

Referring to FIG. 3, the rotating shaft 210 is divided into three sections along the axial direction, and each of the sections of the rotating shaft 210 includes at least one roller 220 including the magnetic unit 10. That is, each of the sections of the shaft 210 includes at least one roller 220, and at least one roller 220 of each section of the shaft 210 is provided with the magnetic unit 10. In this way, when the panel 300 is slid to the rotating shaft 210, at least three rollers 220 equipped with the magnetic unit 10 on the rotating shaft 210 come into contact with the substrate 300. Even if the substrate 300 or the rotating shaft 210 is partially deformed, there is still the roller 220 contacting with the substrate 300 such that the normal operation of the sensor 100 may not be affected.

It can be understood that, as shown in FIG. 3, the rotating shaft 210 is divided into three sections to set at least three magnetic units 10 on the roller 220. In other embodiments, the rotating shaft 210 may be configured to different sections, as long as it is ensured that at least one roller 220 can be correspondingly disposed on each segment of the shaft 210. In an extreme case, each of the rollers 220 on the rotating shaft 210 may be equipped with the magnetic unit 10 so as to ensure normal operations of the sensor 100.

It can be understood that in the multiple sections where the rotating shaft 210 is divided, the arrangement of the magnetic unit 10 may be uniformly distributed on the rotating shaft 210. That is, the roller 220 having the same interval is selected on the rotation shaft 210, and the magnetic unit is disposed in the roller 220. The uniform arrangement prevents errors due to uneven distribution of the magnetic unit 10.

It can be understood that the maximum length of the coil 20 inside the shaft 210 along the axis of the shaft 210 needs to exceed the position of the magnetic unit 10 farthest from the sensing circuit 30 so that each of the magnetic force lines generated by the magnetic unit 10 can be cut by the coil 20, and a current can be generated and received by the sensing circuit 30.

In another embodiment, because manufacturing tolerances of a plurality of the rollers 220 are affected, there may also be a height difference between the coaxially disposed rollers 220, thereby affecting the roller 220 and the substrate with smaller diameters. The outer diameter of the roller 220 equipped with the magnetic unit 10 is not smaller than the outer diameter of the remaining rollers 220. That is, the diameter of the roller 220 equipped with the magnetic unit 10 may be greater than or equal to the diameter of the remaining rollers 220. Therefore, when the roller 220 equipped with the magnetic unit 10 is disposed on the rotating shaft 210, the roller 220 can be slightly higher than or equal to the rotating roller 220. When the substrate 300 slides to the rotating shaft 210, the roller 220 is slightly omitted. The roller 220 equipped with the magnetic unit 10, which is higher than or equal to the rest of the rollers 220, can ensure contact with the substrate 300.

The above embodiment is directed to the flow direction of the substrate 300 perpendicular to the non-contact phenomenon of the roller 220 and the substrate 300. However, there may also be a problem of height difference between a plurality of the shafts 210 arranged side by side in the flow direction along the substrate 300. If the rotating shaft 210 provided with the sensor 100 is lower than a plurality of the shafts 210 adjacent to the front and rear sides of the sensor 100, no matter how many sensors 100 are installed on the rotating shaft 210, corresponding locations of the substrate 300 may not obtained. For this purpose, the sensor 100 may be disposed on the two adjacent shafts 210 of the shaft 210 disposed side by side on the machine table 200 to avoid the occurrence of the above phenomenon, and the sensor 100 may be improved. The reliability.

The above description is merely the embodiments in the present disclosure, the claim is not limited to the description thereby. The equivalent structure or changing of the process of the content of the description and the figures, or to implement to other technical field directly or indirectly should be included in the claim.

What is claimed is:

1. A sensor for sensing a location of a substrate on a machine table for manufacturing liquid crystal panel, the machine table comprises rotating shafts fixed thereon and rollers sleeved on the rotating shafts, the rollers are arranged and configured to slide along an axis direction of the rotating shaft, the sensor comprising:
a magnetic unit, at least one coil, and a sensing circuit;
the magnetic unit being fixed on at least one roller;
the coil being arranged within the rotating shaft, a winding direction of the coil being along an axis direction of the rotating shaft, and the coil being an open-loop circuit; and
the sensing circuit connecting with the coil to form a closed-loop circuit, and the closed-loop being configured to detect a current generated when the coil senses a rotation of the roller to detect a location of the substrate.

2. The sensor as claimed in claim 1, wherein the coil comprises two poles protruding from the shaft, and the sensing circuit comprises two wires respectively connecting the two poles of the coil, and an indicator connecting between the two wires.

3. The sensor as claimed in claim 2, wherein the sensing circuit further comprises a current amplifier for amplifying current signals sensed by the sensor.

4. The sensor as claimed in claim 3, wherein the sensing circuit further comprises an signal processing unit for converting the current sensed by the sensor into electrical signals.

5. The sensor as claimed in claim 1, wherein the magnetic unit comprises at least one pair of N-pole magnetic unit and S-pole magnetic unit, and at least a portion of a magnetic force line formed by the N-pole magnetic unit and the S-pole magnetic pole passes through the rotating shaft.

6. The sensor as claimed in claim 5, wherein the magnetic unit is sealed inside the roller.

7. The sensor as claimed in claim 2, wherein the magnetic unit comprises at least one pair of N-pole magnetic unit and S-pole magnetic unit, and at least a portion of a magnetic force line formed by the N-pole magnetic unit and the S-pole magnetic pole passes through the rotating shaft.

8. The sensor as claimed in claim 7, wherein the magnetic unit is sealed inside the roller.

9. The sensor as claimed in claim 3, wherein the magnetic unit comprises at least one pair of N-pole magnetic unit and S-pole magnetic unit, and at least a portion of a magnetic force line formed by the N-pole magnetic unit and the S-pole magnetic pole passes through the rotating shaft.

10. The sensor as claimed in claim 9, wherein the magnetic urns is sealed inside the roller.

11. The sensor as claimed in claim 4, wherein the magnetic unit comprises at least one pair of N-pole magnetic unit and S-pole magnetic unit, and at least a portion of a magnetic force line formed by the N-pole magnetic unit and the S-pole magnetic pole passes through the rotating shaft.

12. The sensor as claimed in claim 11, wherein the magnetic unit is sealed inside the roller.

13. The sensor as claimed in claim 1, wherein the rotating shaft is divided a plurality of sections along the axial direction, and each of the sections of the rotating shaft comprises at least one roller 220 having the magnetic unit.

14. The sensor as claimed in claim 1, wherein an outer diameter of the roller having the magnetic unit is not smaller than the outer diameter of other rollers.

15. The sensor as claimed in claim 1, wherein the sensor comprises a plurality of sets of coils arranged inside the rotating shaft, and the coils are connected in series as an open-loop circuit.

16. The sensor as claimed in claim 1, wherein the rollers are arranged side by side on the machine table, and the sensor is arranged between two adjacent shafts.
